(19) United States
(12) Patent Application Publication
(10) Pub. No.: US 2006/0031327 A1
(43) Pub. Date: Feb. 9, 2006

(54) Enhanced electronic mail server

(76) Inventor: Thomas J. Kredo, Rochester, NY (US)

Correspondence Address: Thomas R. FitzGerald, Esq., Suite 210, 16 E. Main Street, Rochester, NY, 14614-1803, US

(21) Appl. No.: 10/887,018

(22) Filed: Jul. 7, 2004

(51) Int. Cl. G06F 15/16

(52) U.S. Cl. 709/206; 709/203

(57) ABSTRACT

An enhanced mail server to transform electronic mail messages according to a set of rules controlled by the server's administrators. The server appends, embeds, or links promotional, informational, and organizational information to outgoing and incoming electronic mail messages, and reformat the mail messages into HTML form. Checks are provided to insure that electronic mail senders consent to the attachment of information at the enhanced mail server. A billing process is also provided for billing the entity providing the information being attached. The information to be attached, embedded, or linked may be one or more commercial, small business, corporate, special interest, or targeted advertisements, one or more personal, group, appointment, or event calendars, one or more organizational messages, one or more family photos, or any other information considered appropriate by the server's owners and administrators. To select the appropriate information to send with a particular message, a lookup table, database, or rule base is used to associate elements of the message with a specific set of items of information and a specific set of actions to be taken to transform the message. The message's From address, To address, Reply-To address, some combination of these three, and any other element or part of element in the message form a composite key or set of conditions to perform a series of lookups in the table, database, or rule base. On retrieval of records from the database, or upon application of rules from the rule base, the message is transformed according to the rules for which the message conditions apply.

### FIELD OF THE INVENTION

This invention relates to software for the delivery of electronic mail, and more specifically to server software for the delivery of electronic mail with attachments and notifications concerning electronic mail being delivered.

### BACKGROUND OF THE INVENTION

In processing electronic mail (e-mail) messages for the Internet, server systems execute standard operations on e-mail messages according to current Internet standards (e.g., RFC 2822). Conventional server system practice leaves the body and attachments of an e-mail message unchanged in the passage of the e-mail message from the sender to the receiver.

Exceptions to conventional practice occur when a server system executes security software to detect and remove virus or worm software, also known as ‘malware’, from an e-mail message, or when a server system executes screening software to detect and remove bulk e-mail attachments, also known as ‘spam’ attachments, from an e-mail message. Another form of exception to conventional practice occurs when a server system cannot deliver a message to its intended recipient, and must return the message to the sender with additional information embedded or attached to explain the failure.

Frequently an organization needs to promulgate information when its members or representatives correspond with other individuals or groups outside the organization. For example, a company with a new product line would like its sales representatives to inform their clients of the new products. In conventional practice, the company directs the sales representatives to furnish product announcements and related materials to their clients. Each sales representative may respond to the directive differently or may not respond at all.

In another example, an Internet service provider (ISP) wishes to inform anyone who is not one of its clients concerning its terms of service for those who are its clients. In current practice, such a process of informing others requires public notification and advertising, most of which is wasted on people who have no interest or need to know such things.

In a third example, a company wants to inform its users of electronic mail concerning e-mail malware (software transmitted for the purpose of damaging, blocking, or penetrating the company's computer networks). In current practice, such a process requires sending separate e-mails to the users.

In a fourth example, two organizations wish to apply electronic mail message security and integrity policies to specific classes of electronic mail between them. In conventional practice, such policy application requires education of users and monitoring of e-mail traffic, and even in the best of cases many lapses in message security and integrity occur.

In a fifth example, a retail store wishes to attach targeted advertisements to its outgoing electronic mail messages, selecting different advertisements to be sent to different groups of recipients. Conventional practice is to send independent e-mails to targeted groups.

The automated management of electronic mail message attachments, integrity, and security for different classes of electronic mail would simplify greatly the tasks of information management for many organizations.

### GLOSSARY OF TERMS

Each of the following terms is used in this specification and claims with the meaning associated with it in this section.

Attach—to append a copy of an electronic document to an electronic mail message to be sent, thereby augmenting the message, so that a receiver of the message receives a copy of the electronic document along with the message.

Attachment—an electronic document appended to, but identifiably separate from, an electronic mail message.

Conceal—to encode or encrypt the content of an electronic mail message in order to prevent its misuse by other than the intended recipient. Example: encrypting an electronic mail message using PGP and the recipient's public key.

Electronic document—a text document, image, sound file, video file, or other storeable electronic file capable of retrieval and presentation for a human reader's comprehension.

Electronic mail message—also called an “e-mail message” or an “e-mail”. An electronic document for transmission from an originator to a recipient, comprising a header, a body, and one or more attachments, in which the header contains information controlling and recording the processing of the message itself, and the body and attachments contain information for use by the recipient or recipients of the message.

Embed—to place a copy of an electronic document within an electronic mail message to form an integral part of the message, thereby reformatting and augmenting the message. Example: copying the content of a memo into the body of an electronic mail message containing other information, so as to make the message read in order as if the memo contents are a part of the message text.

Link (n.)—an identifying name or pointer which locates an electronic document within a network context. A link constitutes an electronic document in itself.

Link (v.)—to append to or embed within electronic mail message an identifying name or pointer which locates a separate electronic document within a specified or mutually understood network context, thereby augmenting and possibly reformatting the message. Example: embedding in an electronic mail message an HTTP link to a document at a Website.

Network context—an identifiable region of the memory or storage space within one or more interconnected computers.

Protect—to embed error-correcting or error-detecting codes within or attach error-correcting codes or error-detecting codes to an electronic mail message in order to provide for the reconstruction of the message from part of its received content. Example: constructing a Hamming code from a message text and appending it to the message before transmission, so that the recipient may attempt to reconstruct the message content correctly in the event of errors or faults in message transmission.

Reformat—to reorganize or translate the representation of part or all of an electronic mail message to facilitate its processing by the recipient of the message. Example: converting a text message into an image file for reading on the screen.

Transform—to alter the form and possibly the content of an electronic mail message to protect, conceal, augment, or reformat the content of the message.

### SUMMARY OF THE INVENTION

The invention uses an enhanced mail server to transform electronic mail messages according to a set of rules controlled by the server's administrators. The server appends, embeds, or links promotional, informational, and organizational information to outgoing and incoming electronic mail messages, and reformats the mail messages into HTML form.

The invention provides for checks to insure that electronic mail senders consent to the attachment of information at the enhanced mail server. The invention also provides for billing the entity providing the information being attached.

The information to be attached may be one or more commercial, small business, corporate, special interest, or targeted advertisements, with teen advertisements as an example; one or more personal, group, appointment, or event calendars, one or more organizational messages, one or more family photos, or any other information considered appropriate by the server's owners and administrators.

To select the appropriate information to append to a particular message, the invention uses a lookup table, database, or rule base to associate elements of the message with a specific set of items of information and a specific set of actions to be taken to transform the message. The invention uses the message's From address, To address, Reply-To address, some combination of these three, and any other element or part of element in the message to form a composite key or set of conditions to perform a series of lookups in the table, database, or rule base. On retrieval of a record from the database, or upon application of rules from the rule base, the invention takes action to transform the message according to the rules for which the message conditions apply.

### BRIEF DESCRIPTION OF THE DRAWINGS

FIG. 1 shows a conceptual diagram of the invention.

FIG. 2 shows an overview of the invention's structure and operation in a single sending-server embodiment.

FIG. 3 shows an overview of the invention's structure and operation in a single receiving-server embodiment.

FIG. 4 shows an overview of the invention's structure and operation in a two-server embodiment.

FIG. 5 shows an overview of the invention's structure and operation in a multi-server embodiment.

FIG. 6 shows an overview of the invention's structure and operation in a one-way message transformation embodiment.

FIG. 7 shows an overview of the invention's structure and operation in a two-server embodiment with message transformation processing.

FIG. 8 shows an overview of the invention's structure and operation in a single sending-server embodiment with message transformation processing.

FIG. 9 shows the sending server side detail of the invention.

FIG. 10 shows the receiving server side detail of the invention.

FIG. 11 shows an overview of an enhanced embodiment of the invention.

FIG. 12 shows an overview of the invention's structure and operation in a two-server embodiment in which sending server and receiving server can access each other's server databases.

### DETAILED DESCRIPTION OF THE INVENTION

A typical electronic mail message from a sender to a recipient passes through one or more primary server systems in the process of its communication. The invention provides a means of selecting and appending information to the message based on one or more database or rule lookups in one or more of the communicating primary servers en route. The invention also provides a means for transforming the message based on one or more database or rule lookups in one or more of the communicating primary servers en route. The database or rule lookups and the resulting actions are under the control of administrators or other parties, and are not determined by either the sender or the receiver(s) of the messages on which the invention acts. The invention performs the database and rule lookups based in part on the contents of either the message body, the message header, or both.

The information appended by the invention provides content to be read by the recipient of the message in addition to the content provided by the sender.

The information appended by the invention also contains one or more secondary processing elements such as links which, on being processed by a recipient's browser, require the retrieval of additional elements such as images from any of several secondary server systems. Such links are used in the Hypertext Transfer Protocol (HTTP) for the retrieval of images from a server. The images retrieved from the server are displayed by the recipient's browser as parts of an e-mail message. Each link may contain the identifier of a file to be retrieved from a secondary server system and one or more parameters to be processed by the secondary server system and other systems as required. When the recipient's browser program opens an HTML e-mail message containing a link, the browser reads the link and attempts to retrieve the file to which the link refers. The link may refer to a file within the secondary server computer system. The browser sends a retrieval request to the secondary server computer system. The secondary server computer system responds to the request by retrieving the requested file, transmitting the requested file to the browser's system, and taking any other action for which it is programmed on the basis of the receipt of the retrieval request.

Any secondary server system may be one of the primary server systems through which the electronic mail message passes en route to its recipient.

The invention comprises a software electronic mail processing computer program operating in one or more electronic mail server computers, and a software database access program operating in one or more database system computers. The software electronic mail processing computer program and the software database access program may operate in the same combined server computer.

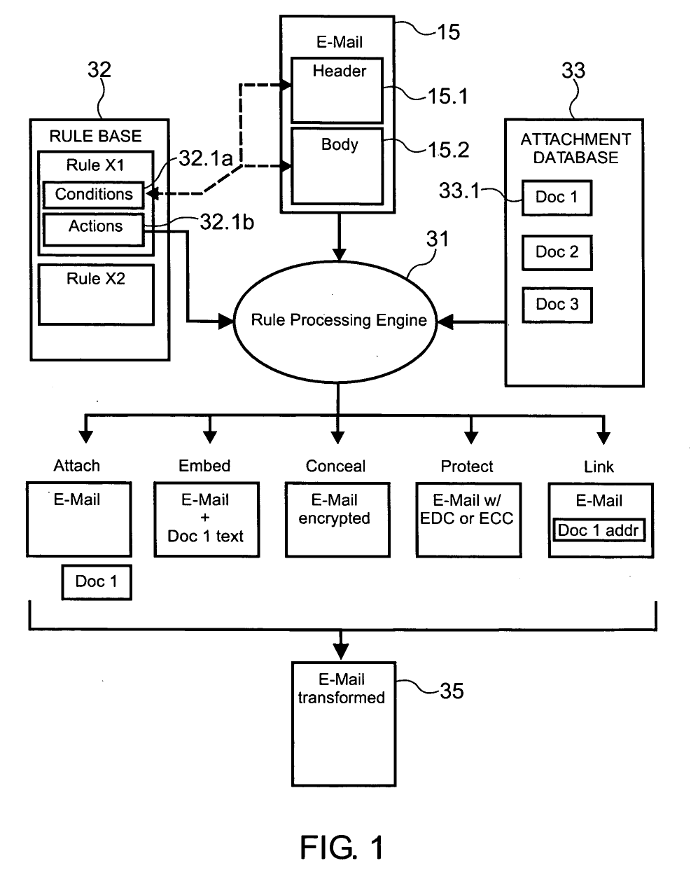

FIG. 1 shows an overview of the sending server side of the invention's processing. An e-mail 15 arrives at the sending server computer. The sending server computer analyzes the data elements of e-mail 15, including information in header 15.1 such as the From-address, sending domains, To-address, To-domain, and the Subject, and information in the body of the message such as the message text 15.2.

The sending server computer sends the e-mail's data elements to the sending server database system. The sending server database system matches the values of the e-mail's data elements to the conditions in rules in its outgoing processing rules database 32. If the values of data elements of e-mail 15 match conditions 32.11 in a rule 32.1, the rule processing engine program 31 of the sending server database system executes actions 32.12 in rule 32.1.

Actions comprise attaching a document to the e-mail, embedding information in the e-mail, concealing the contents of the e-mail, protecting the contents of the e-mail, and storing a link in the e-mail. Documents 33.1 specified for attachment to an e-mail are stored and maintained in an attachments database 33. A rule may contain one or more actions to be applied to an e-mail.

The output from the sending server database system is a transformed e-mail 35. The sending server computer then transmits transformed e-mail 35 to the next Internet destination.

An analogous process may take place at receiving servers and at relaying servers, using an analogous set of software programs.

To select information to be appended to a message, the invention reads an electronic mail message, determines from data elements in the message and from its own contextual information a key for retrieving information to be appended, retrieves the information to be appended using the retrieval key, appends the retrieved information to the message, conditions the message so that the appended information can be read using a conventional browser program, and forwards the message to the next stage in its communication to the recipient.

The invention's contextual information comprises the current date and time, the server's domain identity (such as corporate or organizational component identity), or any other information maintained in the server. The data elements in the message used by the invention comprise the From address, To addresses, Reply-to address, Cc-addresses, Bcc-addresses, Subject, message date and time, priority, message text, and any other message data elements.

To determine from data elements in the message and from its own contextual information a key for retrieving information to be appended, the invention incorporates and applies a rules database containing combinations of conditions to be tested against the content of each message and sets of actions to be performed for each combination of conditions found. The rules database may contain and apply rules of inheritance reflecting a hierarchy of actions that may vary based on the conditions met by a particular message.

For example, for all messages originating from any location within a company, a first rule is applied stating that the company logo and stock price are to be appended to all outgoing messages going to the addresses in the domains of any of a list of investment brokerages. But a second rule beneath the first rule in the hierarchy of rules may state that the stock price is to be suppressed for all messages going to a particular destination address or set of destination addresses within the domains of a particular brokerage or set of brokerages. Application of the two rules together causes the second rule to override the part of the first rule concerning the posting of the stock price, so that any outgoing messages matching the second rule as well as the first rule will have the company logo attached but not the stock price.

The rules database may take any form well-known in the art. In a preferred embodiment, the invention's rules database is implemented as a forward-chaining (data-driven) expert-system rule base with inheritance, in which each rule comprises a set of conditions to be met and a set of actions to be taken in the event that the rule's conditions are met. In the preferred embodiment, the rules to be applied to e-mail messages may be conveniently changed to meet changing needs of the server administrators and the parties they represent.

In all embodiments of the invention's rules database, regardless of the location or system in which the rules are stored, the management of the rules database is under the control of parties other than the sender and recipient of the messages.

The invention's software mail processing computer program operates in one or more server computers along the path taken by an electronic mail message. As the mail message passes through each server computer, the invention's software mail processing computer program appends information to the mail message according to both the data elements in the message and the invention's contextual information maintained in said server computer. If a first instance of the invention's software mail processing computer program operating in a first server computer has already appended information to a mail message incoming to a second server computer, a second instance of the invention's software mail processing computer program operating in the second server computer may use the information appended by the first instance of the invention's software mail processing computer program in the same manner as it uses the data elements in the message itself to determine the selection of additional information to be appended.

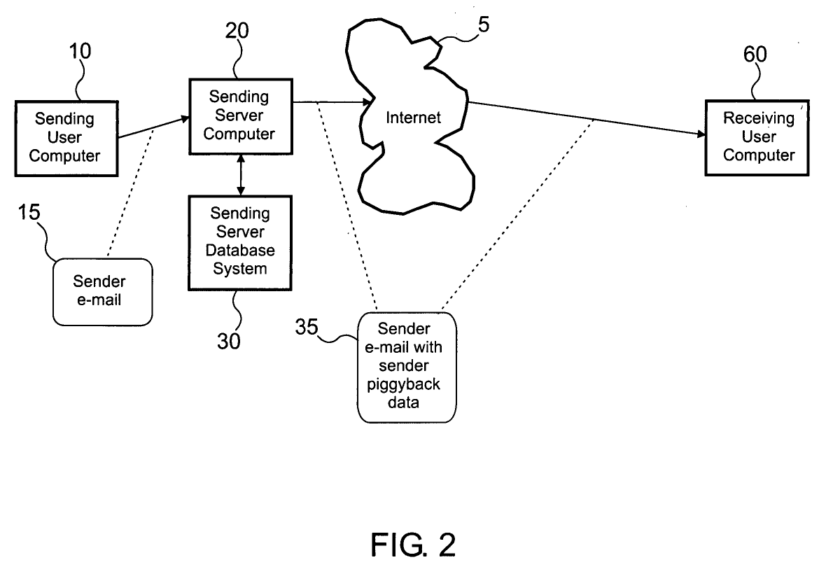

See FIG. 2 for an overview of the invention's layout in a sending-server embodiment. Sending user computer 10 sends a sender e-mail 15 to a sending server computer 20. Sending server computer 20 accesses sending server database system 30 to obtain rules for attaching information to the e-mail 15, and to obtain the information to be attached to e-mail 15. Sending server database system 30 applies the rules and attaches the information required by the rules to the message, creating a sender e-mail with sender piggyback data 35 in the form of attachments. Sending server computer 20 sends e-mail 35 out to the Internet 5 for transmission to receiving user computer 60.

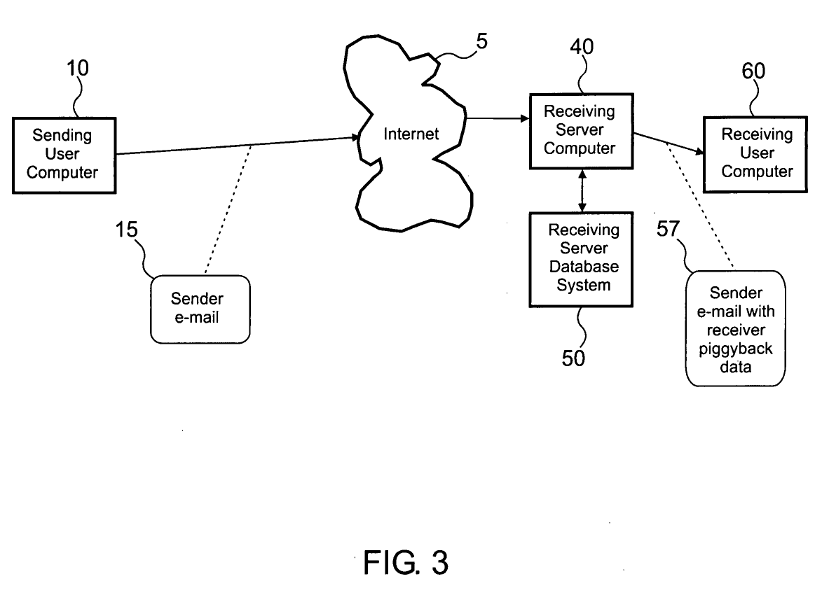

See FIG. 3 for an overview of the invention's layout in a receiving-server embodiment. Sending user computer 10 sends a sender e-mail 15 to the Internet 5 for transmission to receiving server 40. Receiving server computer 40 accesses receiving server database system 50 to obtain: 1) rules for attaching information to the e-mail 35, and 2) additional information to be attached to e-mail 15. Receiving server database system 50 applies the rules and attaches the information required by the rules to the message, creating a sender e-mail with sender and receiver piggyback data 57 in the form of attachments. Receiving server computer 40 sends e-mail 57 to receiving user computer 60 for delivery.

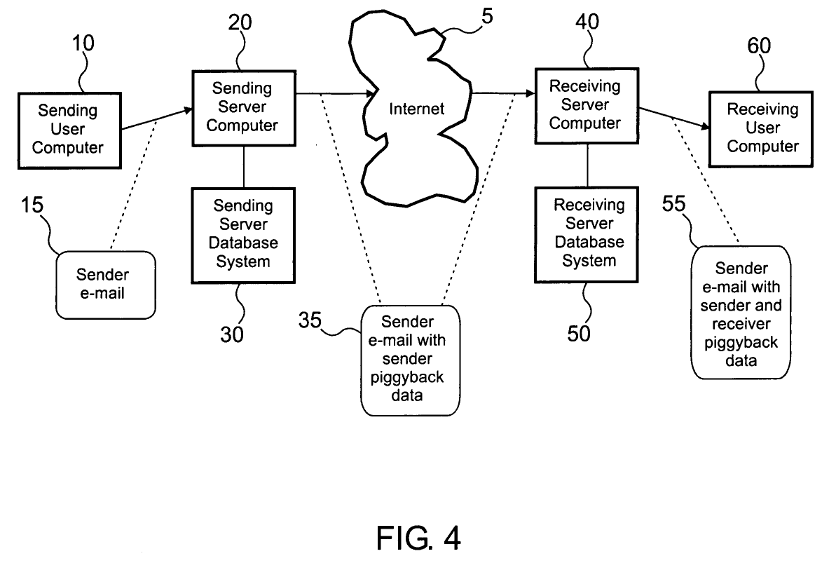

See FIG. 4 for an overview of the invention's layout in a combined sending-server and receiving-server embodiment. Sending user computer 10 sends a sender e-mail 15 to a sending server computer 20. Sending server computer 20 accesses sending server database system 30 to obtain rules for attaching information to the e-mail 15, and to obtain the information to be attached to e-mail 15. Sending server database system 30 applies the rules and attaches the information required by the rules to the message, creating a sender e-mail with sender piggyback data 35 in the form of attachments. Sending server computer 20 sends e-mail 35 out to the Internet 5 for transmission to receiving server 40.

On receipt of e-mail 35, receiving server computer 40 accesses receiving server database system 50 to obtain: 1) rules for attaching information to the e-mail 35, and 2) additional information to be attached to e-mail 35. Receiving server database system 50 applies the rules and attaches the information required by the rules to the message, creating a sender e-mail with sender and receiver piggyback data 55 in the form of attachments. Receiving server computer 40 sends e-mail 55 to receiving user computer 60 for delivery.

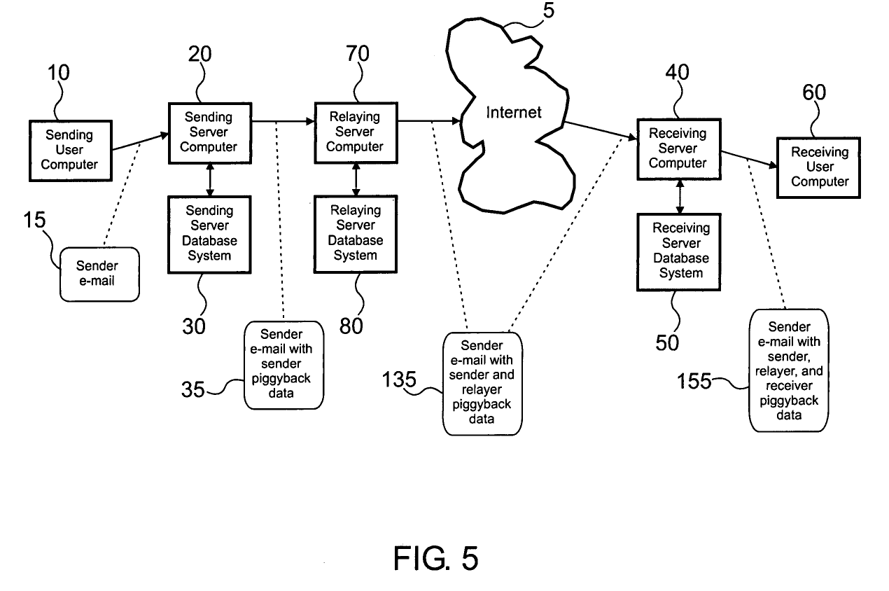

In a multiple-server embodiment, the sending server, one or more relaying servers, and the receiving server affects the e-mail. See FIG. 5. Once e-mail 35 leaves sending server computer 20, it is processed in succession by one or more relaying server computers 70. As for the sending server 20 and the receiving server 40, a first relaying server 70 accesses a relaying server database system 80 to obtain: 1) rules for attaching information to incoming e-mail 35, and 2) additional information to be attached to e-mail 35. Relaying server database system 80 applies the rules and attaches the information required by the rules to the message, creating a sender e-mail with sender and relayer piggyback data 135 in the form of attachments for receipt by the end user at receiving user computer 60. Relaying server computer 70 sends e-mail 135 out to the Internet 5 for transmission to receiving server 40 or to a next relaying server computer 70.

Each successive server operates on the e-mail message sent by the preceding server, either the e-mail 35 from the sending server in the case of the first relaying server, or the e-mail 135 in the case of any subsequent relaying server or receiving server.

The invention incorporates sending-server one-way content transformation embodiments, including one or more processes for reformatting the contents of the e-mail into different forms for presentation to the receiving user. For example, a text message may be converted to an image file or an audio file, to be read or heard by the user at receiving user computer 60.

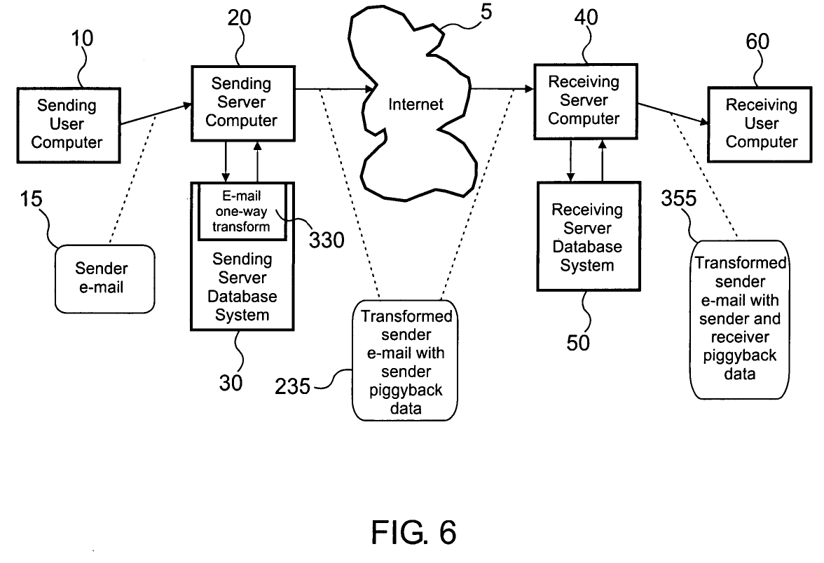

See FIG. 6. In a sending-server one-way content transformation embodiment, the server 20 performs a transformation of the e-mail content itself to produce a representation in a form preferred by the user at receiving user computer 60. Sending user computer 10 sends a sender e-mail 15 to a sending server computer 20. Sending server computer 20 accesses sending server database system 30 to obtain rules for attaching information to the e-mail 15 and transforming the representation of the contents of e-mail 15, and to obtain the information to be attached to e-mail 15. Sending server database system 30 applies the rules, attaches the information required by the rules to the message, and transforms the message's representation according to one-way transform 330, creating a transformed sender e-mail with sender piggyback data 235 in the form of attachments. Sending server computer 20 sends e-mail 235 out to the Internet 5 for transmission to receiving user computer 60. FIG. 6 shows a receiving server 40 as in FIG. 4. Receiving server 40 operates on e-mail 235, producing e-mail 335, and sending e-mail 335 to user computer 60.

An example of the use of a one-way content-transformation embodiment is the transformation of an e-mail's text into an image showing the text in an image form easily readable by the eye but not directly readable by a program, thereby hindering or preventing the automated extraction of information from the e-mail by programs accessing the e-mail during its transit of the Internet.

The invention also incorporates receiving-server and relaying-server one-way content transformation embodiments.

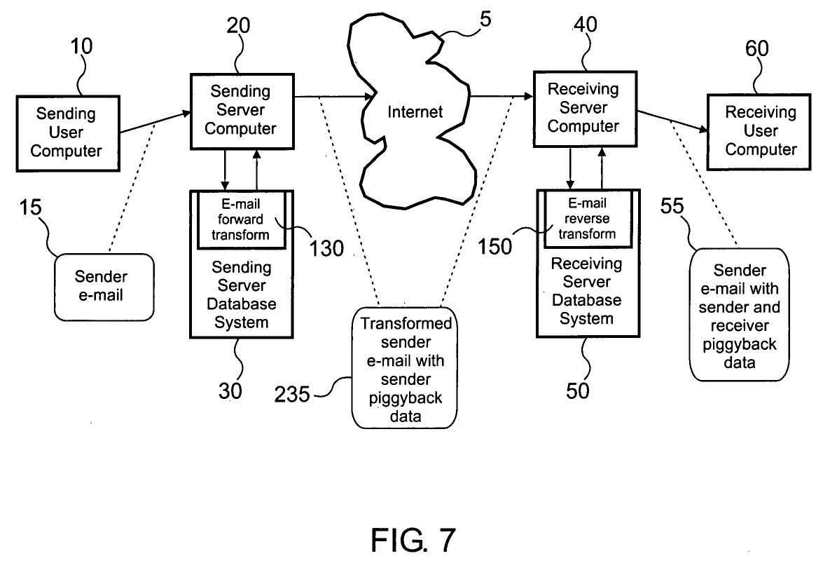

The invention incorporates two-way content transformation embodiments to conceal e-mail message content during its passage to its recipient. See FIG. 7. In a two-server embodiment with two-way content message transformation, a message outbound content transformation process in a sending server alters the form or representation of the e-mail. A corresponding message inbound content transformation process in a receiving server restores the e-mail to its original form.

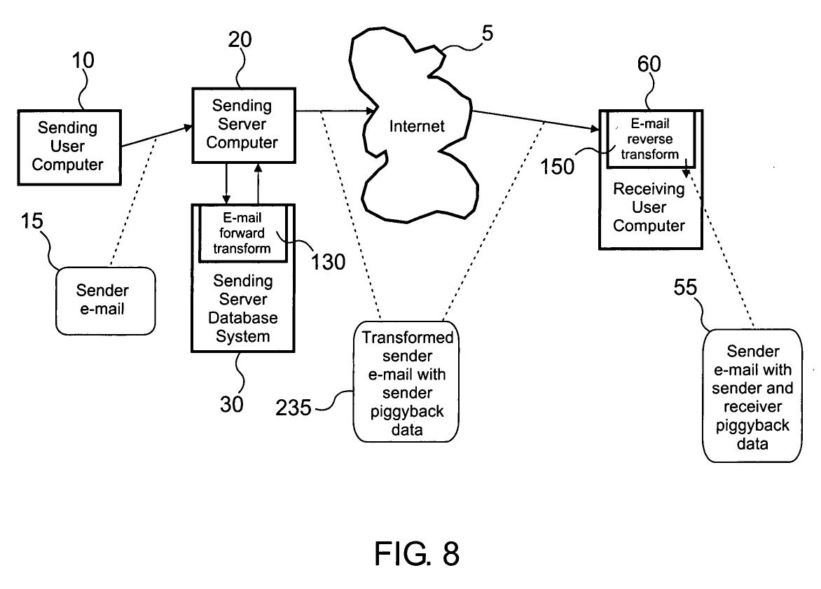

In FIG. 8, the same two-way content transformation is applied, but one or both of the transformation processes operates in one or both of the user computers.

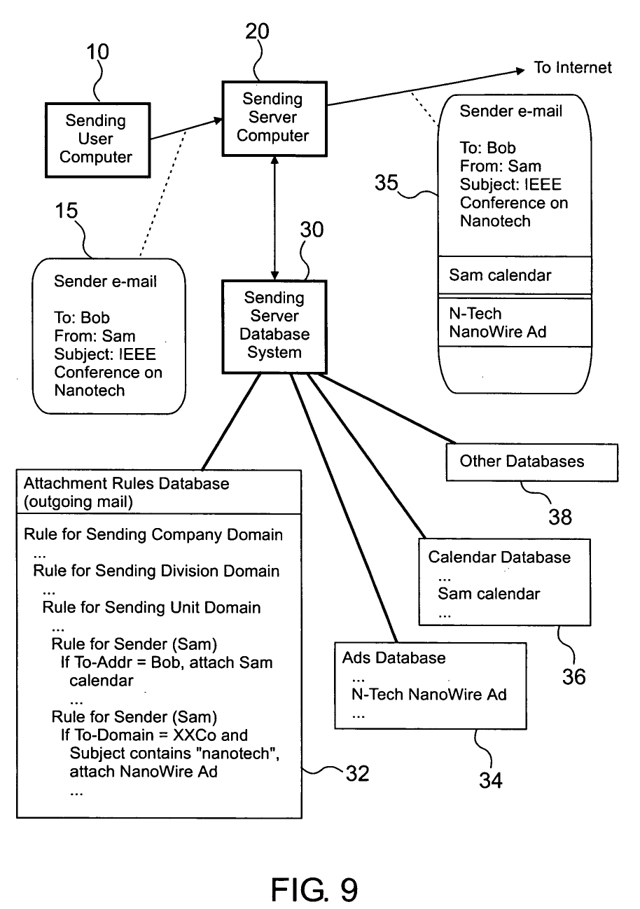

FIG. 9 shows details of the sending side of the invention's processing, in an example. Sam of N-Tech, using sending user computer 10, sends an e-mail 15 to Bob of XX Corp, telling Bob about an upcoming conference on nanotechnology offered by the IEEE. User computer 10 sends e-mail 15 to sending server computer 20. Sending server computer 20 analyzes the data elements of e-mail 15, including the From-address, sending domains, To-address, To-domain, and the Subject. Sending server computer 20 sends the e-mail's data elements to sending server database system 30. Sending server database system 30 compares the contents of the e-mail's data elements to the rules in its outgoing processing rules database 32. As shown, the data elements of e-mail 15 match two rules in outgoing processing rules database 32. The first rule matched, finding Sam as the sender and Bob as the recipient, directs the attachment of Sam's calendar to the e-mail. The second rule matched, finding that XXCo is in the to-domain and the subject is nanotech, directs the attachment of an advertisement for N-Tech's Nanowire product to the e-mail. Sending server database system 30 retrieves Sam's calendar from its calendar database 36, retrieves the N-Tech Nanowire advertisement from its ads database 34, and returns the calendar and the advertisement to sending server computer 20 to be attached to e-mail 15. Sending server computer 20 attaches the calendar and the advertisement to e-mail 15 to create e-mail 35, and sends e-mail 35 to the Internet for delivery to another server.

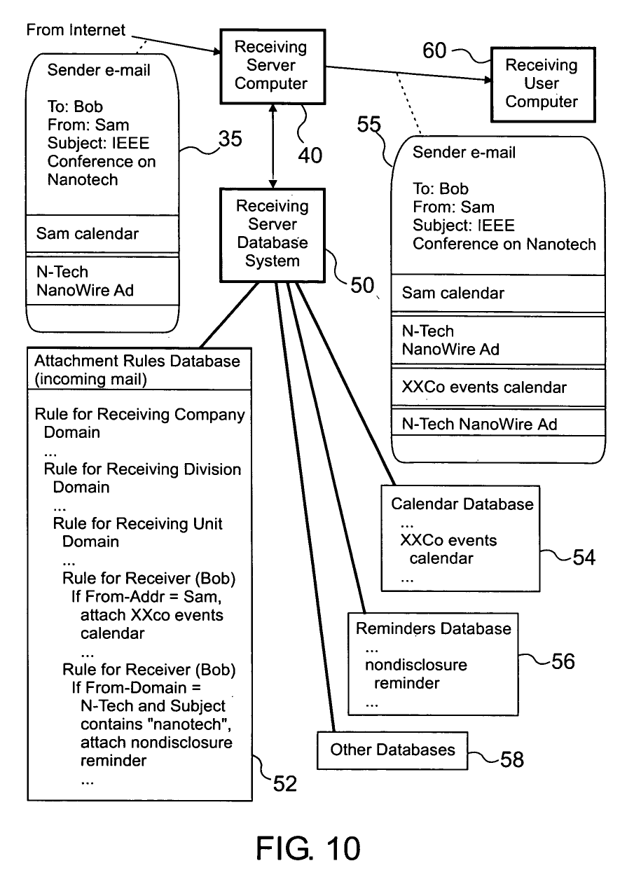

FIG. 10 shows details of the receiving side of the invention's processing. sends e-mail 15 to receiving server computer 40. Receiving server computer 40 analyzes the data elements of e-mail 15, including the From-address, sending domains, To-address, To-domain, and the Subject. Receiving server computer 40 sends the e-mail's data elements to receiving server database system 50. Receiving server database system 50 compares the contents of the e-mail's data elements to the rules in its incoming processing rules database 52. As shown, the data elements of e-mail 15 match two rules in incoming processing rules database 52. The first rule matched, finding Sam as the sender and Bob as the recipient, directs the attachment of the XXco events calendar to the e-mail. The second rule matched, finding that N-Tech is in the from-domain and the subject is nanotech, directs the attachment of a nondisclosure reminder to the e-mail. Receiving server database system 50 retrieves the XXco events calendar from its calendar database 54, retrieves the nondisclosure reminder from its reminders database 56, and returns the calendar and the advertisement to receiving server computer 40 to be attached to e-mail 35. Receiving server computer 40 attaches the events calendar and the nondisclosure reminder to e-mail 35 to create e-mail 55, and sends e-mail 35 to receiving user computer 60.

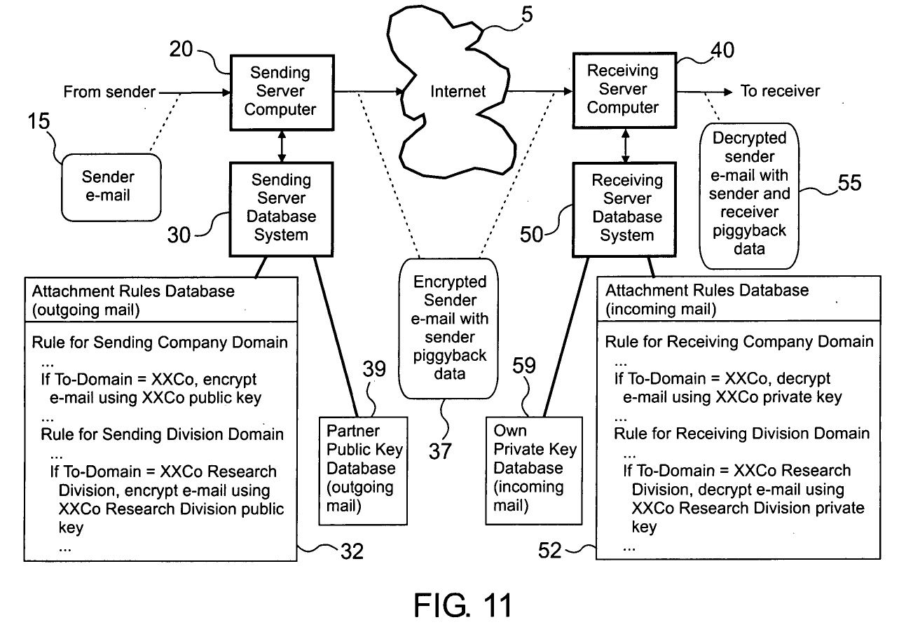

In an enhanced message conditioning embodiment, the invention conditions selected e-mail messages to provide both integrity and security to the content of each message. The process follows the same general flow of information as outlined in FIG. 2. See FIG. 11. A sender e-mail 15 arrives at a sending server computer 20. Sending server computer 20 accesses sending server database system 30 to obtain rules for attaching information to the e-mail 15, to obtain the information to be attached to e-mail 15, and to obtain from a partner public key database 39 any instructions for encrypting e-mail 15 including the public key to be used for the destination of e-mail 15. Sending server database system 30 compares the contents of the e-mail's data elements to the rules in its outgoing processing rules database 32. Sending server database system 30 applies the rules, attaches the information required by the rules to e-mail 15, and encrypts the message and its attachments, creating an encrypted sender e-mail 37 with sender piggyback data in the form of attachments. Sending server computer 20 sends e-mail 37 out to the internet 5 for transmission to receiving server computer 40.

Receiving server computer 40 accesses receiving server database system 50 to obtain from its own private key database 59 any instructions for decrypting e-mail 37 including the private key to be used for the source of e-mail 37, to obtain rules for attaching information to the e-mail 35, and to obtain additional information to be attached to e-mail 35. Receiving server database system 50 compares the contents of the e-mail's data elements to the rules in its incoming processing rules database 52. Receiving server database system decrypts email 37, applies the rules for attachments, and attaches the information required by the rules to the message, creating a decrypted sender e-mail 55 with sender and receiver piggyback data in the form of attachments. Receiving server computer 40 sends e-mail 55 to the receiving user.

The encryption of a copy of the message header of e-mail 15 at sending server computer 20 enables receiving server computer 40 to decrypt e-mail 37 and compare the decrypted header to the actual message header in e-mail 37. Failure of such a comparison indicates possible tampering with e-mail 37 after its departure from sending server computer 20.

In the enhanced message conditioning embodiment, message integrity may also be enhanced by the incorporation of rules in attachment rules databases 32, 52 in order to build and include in each e-mail message 35 or 37 one or more error-checking codes or error-correcting codes as computed and stored by sending server computer 20 and checked and applied for correction by receiving server computer 40.

The invention provides a delivery notification feature that operates in the HTML/HTTP environment. As a part of its attachment process, the sending server attaches to the electronic mail message a file name for an image file to be displayed on the receiving user computer at the time the message is opened. When the recipient opens the message for reading, the browser requests the image file, along with parameter information appended to the file name. The appended parameter information includes the receiving user's e-mail address, a message identifier, and either the e-mail address of the sender of the message or an e-mail address for the return of information from the receiving user computer.

The image file resides on the sending server. When the sending server receives the browser request, the sending server returns to the receiving user computer the requested image file, processes the appended parameter information, and sends the message identifier to the address given in the parameter information.

The invention is not restricted to any particular number of instances of its software operating in a message path. The principal embodiments of the invention's software mail processing computer program operating in server computers includes only one software instance either operating in a sending server computer as shown in FIG. 2, or operating in a receiving server computer as shown in FIG. 3. The invention provides for the insertion of additional instances of both its own software and the supporting servers for that software in a message path as required.

The invention is not restricted to embodiments which define separate server computers 20, 40 and server database systems 30, 50. Systems 20, 30, 40, 50 may be combined in various embodiments. For example, sending server system 20 may be combined with sending server database system 30. In another example, sending server database system 30 may be combined with receiving server database system 50, with access to one or both systems 30, 50 provided via the Internet.

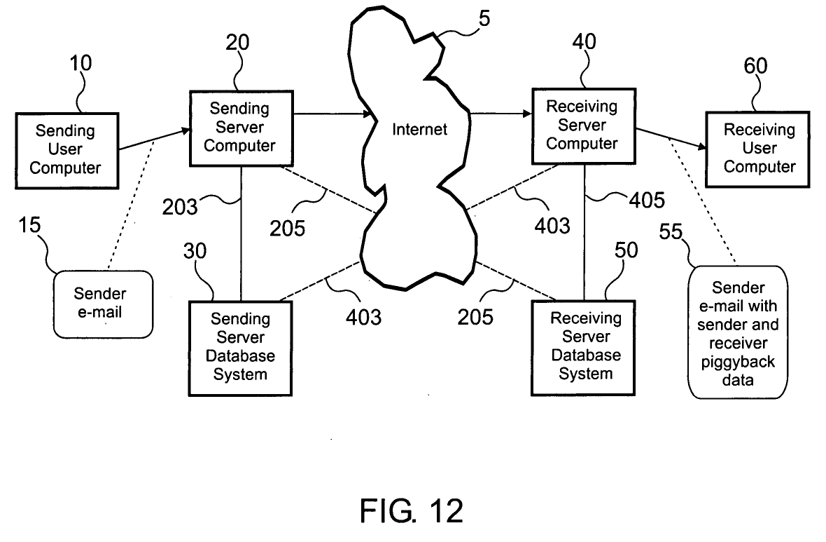

The invention is not restricted to embodiments which restrict definitions of connections between a server computer 20, 40 and server database systems 30, 50. Systems 20, 30, 40, 50 may be interconnected in various embodiments. See FIG. 12. For example, either in addition to or in replacement of its connection 203 to sending server database system 30, sending server system 20 may be connected to receiving server database system 50, via connection 205 over the Internet. Likewise, either in addition to or in replacement of its connection 405 to receiving server database system 30, receiving server system 40 may be connected to sending server database system 30, via connection 403 over the Internet.

The invention is not restricted to the application of public-key encryption and decryption of an entire message and its attachments. Portions of a message may be left in clear as indicated in the processing rules databases 32 and 52. In addition, steganographic encryption and other forms of message transformation well-known in the art may be applied to one or more mail attachments sent between users as indicated in the processing rules databases 32 and 52. Furthermore, symmetric encryption techniques, involving the management of shared keys between sending server systems and receiving server systems, may also be used in the invention.

The invention uses stored rules to determine information to attach to an e-mail, to obtain instructions for transforming or encrypting the e-mail, to obtain instructions for incorporating error-detection and error-correction information in the e-mail, to obtain and attach the information to be attached to the e-mail, to transform or encrypt the e-mail and its attachments, and to incorporate forward error-correction and error-detection components in the e-mail. The invention's stored rules may be implemented as compilable or interpretable program code, tabular lists of rules in a database, an easily-updated flexible rule base as used by an expert system, two or more of these implementations in combination, or any other form well-known in the art.

What is claimed is:

1. An enhanced electronic mail server program comprising:
a message receiving software program for receiving an electronic mail message;
an element locating software program for locating one or more data elements in the electronic mail message;
a value retrieving software program for retrieving values found for the data elements in the electronic mail message;
a rule searching software program for searching for rule-containing records in one or more databases containing information matching the retrieved values found for the data elements;
a rules retrieval software program for retrieving processing rules from the rule-containing records;
a rules application software program for applying the processing rules to the electronic mail message to produce a modified electronic mail message; and
a message transmitting software program for transmitting the modified electronic mail message.

2. The enhanced electronic mail server program of claim 1 wherein the rules application software program further comprises a software program for attaching attachments to the electronic mail message.

3. The enhanced electronic mail server program of claim 1 wherein the rules application software program further comprises a transforming software program for transforming the representation of the content of the electronic mail message.

4. The enhanced electronic mail server program of claim 3 wherein the transforming software program further comprises an encryption program.

5. The enhanced electronic mail server program of claim 3 wherein the transforming software program further comprises a decryption program.

6. The enhanced electronic mail server program of claim 3 wherein the transforming software program further comprises a program for converting text to one or more encoded visual images.

7. The enhanced electronic mail server program of claim 3 wherein the transforming software program further comprises a program for converting text to one or more encoded sound waveforms.

8. The enhanced electronic mail server program of claim 1 wherein the rules application software program further comprises:
an error detection code generation software program for analyzing the content of the electronic mail message to produce an error detection code; and
an error detection code incorporation software program for incorporating the error detection code in the electronic mail message.

9. The enhanced electronic mail server program of claim 1 wherein the rules application software program further comprises:
an error correction code generation software program for analyzing the content of the electronic mail message to produce an error correction code; and
an error correction code incorporation software program for incorporating the error correction code in the electronic mail message.

10. The enhanced electronic mail server program of claim 1 wherein the rules application software program further comprises:
an error detection code retrieval software program for retrieving the error detection code from the electronic mail message;
an error detection software program for analyzing the retrieved error detection code to produce an error detection result;
a software program for applying the error detection result to the electronic mail message to produce an electronic mail message marked as containing errors.

11. The enhanced electronic mail server program of claim 1 wherein the software program for applying the processing rules to the electronic mail message to produce a modified electronic mail message further comprises:
an error correction code retrieval software program for retrieving the error correction code from the electronic mail message;
an error correction analysis software program for analyzing the retrieved error correction code and the electronic mail message to produce an error correction result;
an error correction software program for applying the error correction result to the electronic mail message to produce a corrected electronic mail message.

12. An enhanced electronic mail server comprising:
a server computer connected to one or more user computers, further comprising one or more processors, one or more main memory subsystems, one or more storage devices, one or more connections to each of the one or more sending user computers, one or more connections to the Internet, and means for sending and receiving electronic mail messages;
a server database system, further comprising one or more processors, one or more main memory subsystems, one or more storage devices, and one or more connections to the server computer;
a processing rules database stored in the server database system;
one or more attachment databases stored in the server database system;
one or more rules application software programs operating in the server computer for applying the rules in the processing rules database to an electronic mail message;
one or more attachment processing software programs operating in the server computer for attaching information retrieved from the attachment database to electronic mail messages.

13. The enhanced electronic mail server of claim 12, wherein at least one rules application software program comprises:
a subprogram for reading all or part of the electronic mail message;
a subprogram for selecting one or more rules based upon the contents of the read portion of the electronic mail message; and
a subprogram for applying said selected rules to the electronic mail message.

14. The enhanced electronic mail server of claim 12, wherein the processing rules database further comprises one or more processing rules for transforming the representation of the content of an electronic mail message.

15. A method for enhancing the processing of electronic mail, comprising the steps of:
sending an electronic mail message from a sending user computer to a sending server computer;
analyzing the electronic mail message on the sending server computer to determine values from the contents of the data elements of the message and its header;
using the values found in the analysis of the electronic mail message and its header to look up outgoing message attachment processing rules in an outgoing processing rules database on a sending server database system;
applying the outgoing message processing rules to the electronic mail message to select outgoing attachments to be attached to the electronic mail message;
attaching selected outgoing attachments to the electronic mail message;
transmitting the electronic mail message to a receiving server computer via the Internet;
receiving the electronic mail message at a receiving server computer;
analyzing the electronic mail message on the receiving server computer to determine values from the contents of the data elements of the message and its header;
using the values found in the analysis of the electronic mail message and its header to look up incoming message processing rules in an incoming processing rules database on a receiving server database system;
applying the incoming message processing rules to the electronic mail message to select incoming attachments to be attached to the electronic mail message; and
attaching selected outgoing attachments to the electronic mail message;
transmitting the electronic mail message to a receiving user computer.

16. The method of claim 15 wherein the step of applying the outgoing message processing rules to the electronic mail message further comprises the steps of:
retrieving information to be attached to the electronic mail message;
attaching the retrieved information to the electronic mail message.

17. The method of claim 15 wherein the step of applying the incoming message processing rules to the electronic mail message further comprises the steps of:
retrieving information to be attached to the electronic mail message;
attaching the retrieved information to the electronic mail message.

18. The method of claim 15 wherein the step of applying the outgoing message processing rules to the electronic mail message further comprises the step of encrypting the electronic mail message.

19. The method of claim 15 wherein the step of applying the incoming message processing rules to the electronic mail message further comprises the step of decrypting the electronic mail message.

20. The method of claim 15 wherein the step of applying the outgoing message processing rules to the electronic mail message further comprises the steps of:
generating message integrity data components from the contents of the electronic mail message;
storing the generated message integrity data components in the electronic mail message.
